(19) United States
(12) Patent Application Publication
(10) Pub. No.: US 2010/0170854 A1
(43) Pub. Date: Jul. 8, 2010

(54) Sludge Dewatering and Drying

(75) Inventors: Dana Casbeer, Angleton, TX (US); Tommy Reeves, Stafford, TX (US); Rubin Bariya, Houston, TX (US)

Correspondence Address: D'AMBROSIO & MENON, LLP, 10260 WESTHEIMER, SUITE 465, HOUSTON, TX, 77042, US

(73) Assignee: SEVERN TRENT DE NORA, LLC, Sugar Land, TX (US)

(21) Appl. No.: 12/648,041

(22) Filed: Dec. 28, 2009

Related U.S. Application Data
(63) Continuation-in-part of application No. 12/621,291, filed on Nov. 18, 2009.
(60) Provisional application No. 61/142,794, filed on Jan. 6, 2009.

(51) Int. Cl. C02F 1/56; B01D 33/00; C02F 11/00; B01D 29/11

(52) U.S. Cl. 210/710; 210/732; 210/198.1; 210/141

(57) ABSTRACT

Methods, apparatus and systems for dewatering and drying the dewatered sludge. Sludge pumped into the sludge dewatering apparatus is mixed in-line with a pre-measured quantity of polymers to agglomerate solids entrained in the sludge. The agglomerated sludge is routed to a filtration station comprising filtration chambers. The filtration chambers are fitted with industry standard filter bag. The agglomerated sludge is subjected to dewatering in the filter bags and the dewatered sludge is subsequently compacted, dried and discarded.

### PRIORITY AND RELATED APPLICATIONS

The present invention claims the benefit of the filing date of U.S. provisional application Ser. No. 61/142,794 filed Jan. 6, 2009. The present invention is a continuation-in-part of U.S. Ser. No. 12/621,291 filed Nov. 18, 2009 which claimed the benefit of the filing date of U.S. provisional application Ser. No. 61/199,676 filed Nov. 19, 2008.

### BACKGROUND AND SUMMARY

The present invention relates to treatment of fluids containing suspended solids and other impurities. In particular, the invention pertains to the filtration and dewatering of marine wastewater.

Current sludge dewatering practices incorporate numerous processes and elaborate systems to collect and manage sludge wastes. Particularly in the specialized field of offshore marine sewage sludge treatment, the processing and disposal of sludge is problematic due to ever increasing environmental regulations and waste discharge rules.

One or more embodiments of the invention pertain to methods, apparatus and systems for dewatering wastewater or sludge comprising entrained solid particulate matter. Removal of substantially all water from the sludge allows for disposal of a smaller volume of dewatered sludge or sludge cake. This, thereby, reduces disposal costs and facilitates environmental compliance pertaining to disposal of sludge.

In one or more embodiments of the invention, sludge generated during wastewater treatment is mixed with a pre-measured quantity of one or more polymers to agglomerate solids entrained in the sludge. The mixing may be facilitated by an in-line mixer placed within piping transferring the sludge to a primary filtration station. The addition of polymers facilitates the agglomeration of solids entrained in the sludge. The agglomerated sludge is routed to the primary filtration station. The primary filtration station may comprise one or more lid-enclosed primary filtration chambers. Each of the primary filtration chambers may further define a cylindrical cavity for receiving at least one industry standard filter bag. The agglomerated sludge may be subjected to dewatering in the filter bag. A substantially clarified effluent or filtrate is drained from the sidewalls of the filter bags and agglomerated sludge is retained in the industry standard filter bag. In another embodiment of the invention, the sludge produced during wastewater treatment may be stored in a storage tank until it is ready to be ready with the polymers. In yet another embodiment, the sludge may be treated with the polymers within the storage tank prior to piping the agglomerated stream to the primary filtration station.

The agglomerated sludge may be compacted within the filter bag by mechanically pressing the filter bag. The mechanical pressing may further facilitate dewatering of the agglomerated sludge.

The dewatering of the agglomerated sludge is a mechanical step selected from the group consisting of gravity draining, blow drying, heating, vacuuming, squeezing and pressing.

The time required for filling the filter bag with the agglomerated stream may be determined, and an additional volume of the agglomerated stream may be routed to the same filter hag or to one or more unused filter bags after an interval following the determined time period. The routing of the agglomerated stream may be controlled by one or more selectively actuatable valves.

In one embodiment, a high volume of air may be introduced into the primary filtration chambers to facilitate pressurized dewatering of the agglomerated stream and subsequent drying of the retained agglomerated solids in the filter bag. In yet another embodiment, heated air may be introduced into the primary filtration chambers, by means of an in-line heater, to facilitated dewatering and subsequent drying. The spent or soiled filter bag comprising the dried agglomerated solids may be manually discarded. In another embodiment of the invention, the spent filter bag may be removed and discarded by robotic or automated means.

The drained effluent from the filter bag may be collected in a common piping header. The effluent level in the piping header may be monitored and when the effluent level reaches a pre-determined threshold, the effluent may be discharged.

In another embodiment, a plurality of filtration stations may be coupled to the primary filtration station for facilitating expanded dewatering.

In another embodiment of the invention, a sludge dewatering apparatus comprises a self-contained primary module, the primary module comprising a primary mounting rack for housing: an integral sludge transfer pump; a polymer storage or holding tank; a polymer injection pump connected to the polymer storage tank; an in-line mixer positioned within piping for mixing the one or more polymers with sludge produced during wastewater treatment, a primary filtration station comprising one or more primary filtration chambers, each of the primary filtration chambers defining a cylindrical cavity configured to receive one or more industry standard filter bags therein; and a substantially rigid primary platform perpendiculary oriented and secureably coupled to the primary mounting rack, wherein the primary platform is positioned adjacent to the primary filtration chambers. The primary platform is configured to support the weight of an operator.

The filtration chamber comprises a durable non-corrosive material. In one embodiment, the non-corrosive material comprises polyvinyl chloride (PVC) plastic or coated steel.

The filtration chamber may comprise an upper access lid, the access lid further comprising a handle pivotally connected to the lid.

The industry standard filter bag further comprises at least one pair of built-in handles configured for an operator to conveniently grasp and lift the spent filter hag from the primary filtration chamber.

One or more pairs of dewatering plates may be positioned on either sides of a filter bag. The dewatering plates may be actuated by cylinders or pistons which may be controlled by the control panel. The plates compress the filter bag to further facilitate dewatering of and compacting of the agglomerated sludge.

The sludge dewatering apparatus may further comprise primary piping means for transferring the agglomerated sludge to one or more of the filtration chambers; selectively actuatable valves positioned on the primary piping means, wherein the valves may be pneumatically actuated; and means for controlling the valves.

A piping header may be disposed beneath the filtration chambers. The discharged effluent is collected in the piping header. The sludge dewatering apparatus further comprises automated sensor means for detecting an effluent level in the piping header, and a drainage pump in fluid connection with the common piping header. When the effluent level reaches a pre-determined threshold, the effluent may be drained.

The sludge dewatering apparatus may further comprise an air blower disposed adjacent the filtration chambers.

In another embodiment, the sludge dewatering apparatus further comprises one or more secondary modules disposed laterally, the secondary module comprising a secondary filtration station comprising one or more secondary filtration chambers and a secondary platform, wherein the secondary module is coupled to the primary platform.

In yet another embodiment, a sludge dewatering system comprises: a wastewater treatment system configured to treat wastewater to produce a dechlorinated effluent and sludge, a sludge discharge pipe; a turbidimeter or a turbidimeter sensor installed on the sludge discharge pipe; and a sludge dewatering apparatus configured to receive the sludge from the wastewater treatment system, the sludge dewatering apparatus comprising: a self-contained primary module, the primary module comprising a primary mounting rack for: a sludge transfer pump; a polymer storage tank; a polymer pump in fluid connection with the polymer storage tank; piping means comprising means for mixing the polymer with the sludge to form an agglomerated stream; a primary filtration station for receiving the agglomerated stream, the primary filtration station comprising one or more primary filtration chambers, each of the primary filtration chambers defining a cylindrical cavity configured to receive one or more industry standard filter bags therein; and a substantially rigid primary platform perpendiculary juxtaposed and secureably coupled to the primary mounting rack, wherein the primary platform is positioned adjacent to the primary filtration chambers.

In one or more embodiments of the invention, the discharged effluent may comprise less than 25 mg/L Biological Oxygen Demand (BOD), less than 35 ppm Total Suspended Solids (TSS), less than 120 mg/L Chemical Oxygen Demand (COD) and less than 100 cfu/100 ml coliform.

### BRIEF DESCRIPTION OF THE DRAWINGS

FIG. 1a is an illustration in accordance with one embodiment of the sludge dewatering apparatus of the invention.

FIG. 1b illustrates an embodiment of a filtration bag used in accordance with one embodiment of the sludge dewatering apparatus of the invention.

FIG. 1c illustrates an embodiment of a blower used in accordance with one embodiment of the sludge dewatering apparatus of the invention.

FIG. 2 is an illustration of a front view of one embodiment of the sludge dewatering apparatus of the invention.

FIG. 3 is an illustration in accordance with one embodiment of the sludge dewatering apparatus of the invention.

FIG. 4 is an illustration of an expandable sludge dewatering apparatus in accordance with another embodiment of the invention.

FIG. 5 is an illustration of a flow chart of sludge dewatering system in accordance with another embodiment of the invention.

FIG. 6 is another embodiment of the sludge dewatering apparatus of the invention.

### DETAILED DESCRIPTION

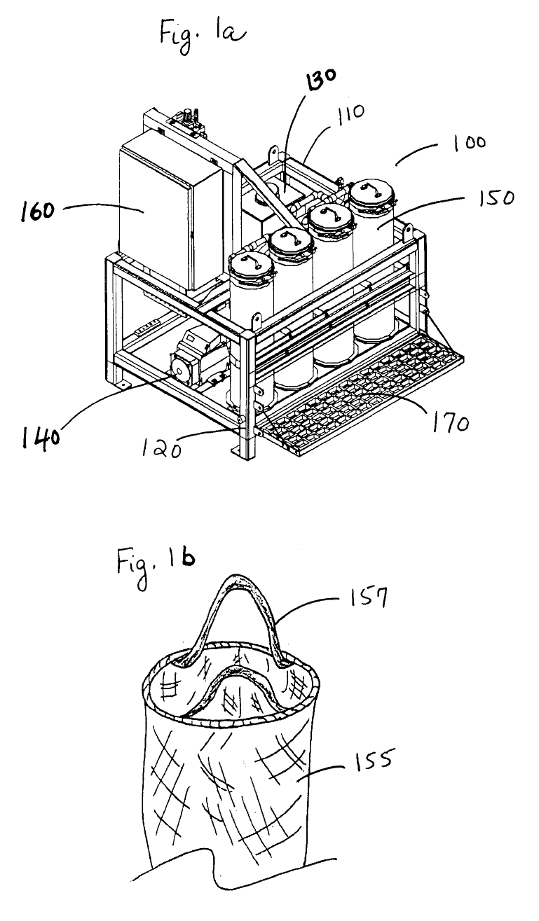

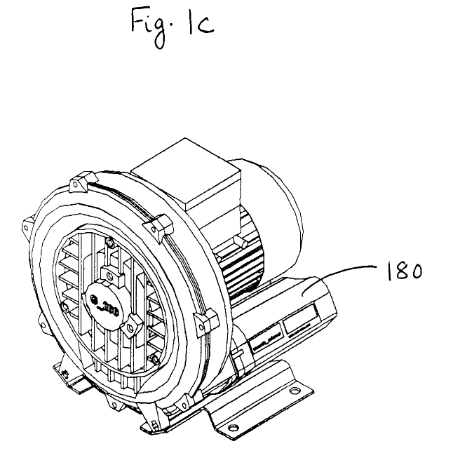

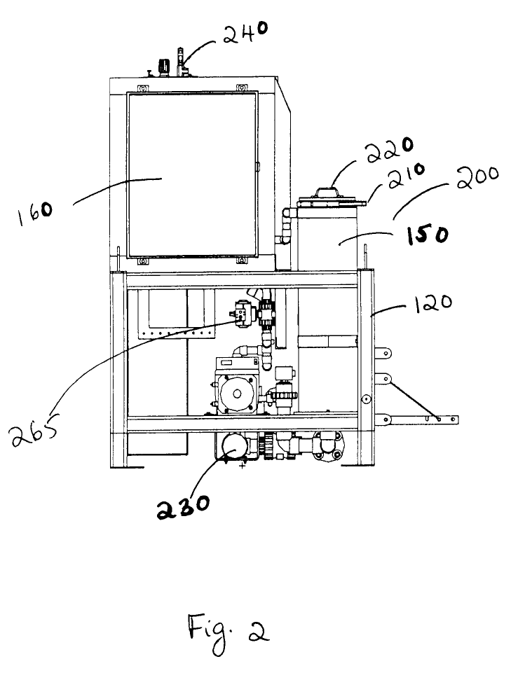

One or more embodiments of the invention relate to methods, systems and apparatus for dewatering fluids, and in particular, for dewatering and subsequently drying the dewatered sludge. Referring to FIG. 1a, an apparatus for dewatering wastewater 100 comprises a self-contained primary module 110. The primary module 110 comprises a primary mounting rack 120 capable of supporting a polymer storage tank 130, a pump for dispensing or injecting polymers 140, a primary filtration station comprising one or more primary filtration chambers 150, a control panel 160 comprising a PLC (programmable logic controller) for automatically controlling the routing of a stream of polymer injected wastewater to the primary filtration chambers 150, and a substantially rigid base or primary platform 170 that is coupled to the primary mounting rack 120. The primary platform 170 may be positioned adjacent to the primary filtration chambers 150. The primary module 110 may range in size from 5×6 feet to 8×8 feet, and from 60-90 inches in height.

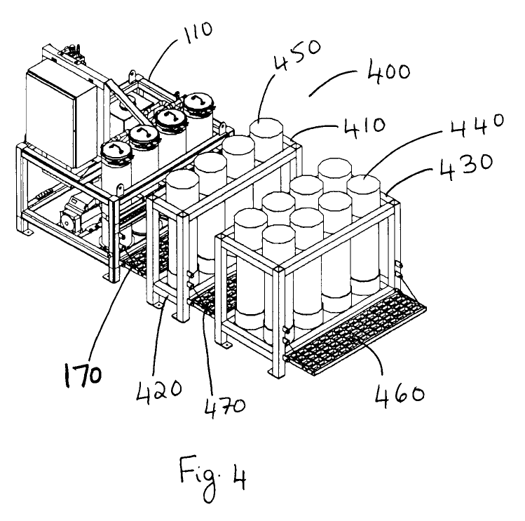

As illustrated in FIG. 3, in another embodiment of the invention 300, an integral sludge transfer pump 320 may be employed to pump the sludge from a sludge discharge line 310 to the primary filtration chambers 150. Sludge pumping is commenced when a turbidity sensor (not shown) installed on the sludge discharge line 310 detects turbidity in the line. The sludge discharge line 310 may be connected on the opposite end to a wastewater treatment system that generates the sludge as a byproduct of wastewater treatment. The sensor may be coupled to the sludge discharge line 310.

Referring to both FIGS. 1 and 3, the sludge discharge line 310 may further comprise in-line valves (not shown) that may be opened or closed at timed intervals depending on the turbidity levels detected by the sensor. When turbidity is detected, the valves open and the sensor transmits a signal to the control panel 160 to commence sludge transfer to sludge dewatering apparatus 100.

Concurrently with the transfer of the sludge, the polymer injection pump 140 may be started. As described earlier, the polymer injection pump 140 may be controlled by the control panel 160 to inject a measured amount of a polymer from the polymer storage tank 130 into the sludge at a polymer injection point 330. In one embodiment of the invention, organic polymers may be introduced into the sludge. Polymers are easy to handle and may require small storage space. The polymers may be mixed in-line with the sludge in the piping 340 transferring the sludge to the filtration chambers 150. The polymers agglomerate the solids entrained in the sludge to produce an agglomerated stream. The sludge comprising the agglomerated solids may be piped to the filter bags. The agglomerations have a slick outer surface which allows the agglomerated solids to slide down the inner walls of the filter bag 150 and collect at the bottom of the filter bag 150. Thus, fouling of the filter bags' inner wall surface may be reduced. This further allows more usable filter bag area for treating the next batch of sludge.

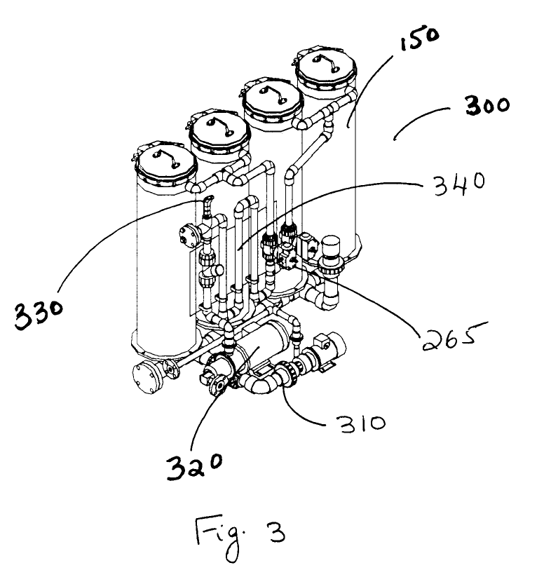

The agglomerated stream may be piped to the primary filtration station. The routing of the agglomerated stream may be accomplished by piping 340. The piping 340 comprises selectively actuatable valves 265. The valves 265 may be controlled by pneumatic controls 240 (see FIG. 2) coupled to the control panel 160. The control panel 160 may ensure that the agglomerated stream only enters a pre-selected filtration chamber 150 by selectively actuating the valves 265. In another embodiment, the agglomerated stream may enter a pair of, or more than one primary filtration chambers 150 concurrently.

The primary filtration station comprises one or more primary filtration chambers 150. In one embodiment, the primary filtration station comprises from 2-8 primary filtration chambers 150. In one exemplary embodiment, as illustrated in FIG. 1a, the sludge dewatering apparatus 100 comprises 4 primary filtration chambers 150. The primary filtration chambers 150 comprise a non-corrosive material. In one embodiment, the primary filtration chambers 150 comprise polyvinyl chloride (PVC) which may be more durable when the sludge dewatering apparatus 100 may be used in corrosive offshore environments. The primary filtration chambers 150 may be between 6-10 inches in diameter and between 38-45 inches in height.

The primary filtration chambers 150 may define a cylindrical cavity. Referring now to FIG. 2, the primary filtration chamber 150 may comprise an upper access lid 210. The access lid 210 encloses the primary filtration chamber 150. The access lid 210 may be sized to snugly fit within an upper aperture in the filtration chamber 210 thereby, sealing the primary filtration chamber 150. Sealing the primary filtration chamber 150 may result in substantially eliminating odors. Additionally, from a safety perspective, the access lid 210 may ensure that the agglomerated stream does not spill over and thereby, pose a hazardous environment to an operator of the sludge dewatering apparatus 100, 200. A handle means 220 may be conveniently coupled to the upper surface of the access lid 210. An operator may be able to easily remove the lid 210 by grasping and tugging on the handle means 220.

Referring to FIGS. 1a and 1b, the primary filtration chambers 150 may be fitted with one or more filter bags 155. In one embodiment, the filter bags may be industry standard bags 155 also known as “sock” filters. Industry standard filter bags allow for cost-containment and may be easy to obtain. The filter bags may have a semi-rigid mounting collar at the opening of the bag for mounting purposes. Consequently, each filter bag may be self-supporting. The industry standard filter bags may further comprise built-in handles 157 for convenient removal from within the primary filtration chamber 150.

When the agglomerated stream enters the filter bag 155, the denser agglomerated solids may be captured and retained at the bottom of the filter bag 155. A less dense effluent that may be substantially devoid of the agglomerated solids passes through the side walls of the filter bag 155 and drains into the base of the primary filtration chamber 150. This substantially clarified effluent may be collected in a common piping header (not shown) positioned on underneath the primary mounting rack 120. A liquid level switch may monitor the level of effluent collected in the common piping header, and once a pre-determined level is reached, the sump pump 230 (as shown in FIG. 2) discharges the effluent. The sump pump 230 may be positioned adjacent the common piping header and underneath the primary mounting rack 120.

As the agglomerated stream is introduced in to the filter bag 155, the control panel 160 calculates the time to fill the filter bag 155. At a predetermined time period, the actuated valves 265 cycle and begin introducing the agglomerated stream into one or more new or unused filter bags. The cycling may allow for the initial capturing or collection of the agglomerated solids and the subsequent draining or dewatering of the solids to allow for further introduction of an agglomerated stream. As described earlier, the drained effluent may be collected in a common piping header and upon reaching a pre-determined effluent level, the sump pump 230 may drain the effluent to a common drain.

In another embodiment of the invention, a fluid level indicator may be incorporated into the primary filtration chambers 150 to indicate the level of the agglomerated stream in the filter bag 155. The agglomerated stream may continue to be introduced into the same filter bag 155 until the liquid level indicator emits a signal that the filter bag 155 has reached a maximum fill capacity. In yet another embodiment, the filter bags 150 may be weighed individually to determine their density pre- and post-introduction of the agglomerated stream. Until a pre-determined threshold is reached, the agglomerated stream may be continued to be introduced into the same filter bag 155. However, when the density reaches or exceeds a pre-determined threshold, the filter bags may be replaced.

Referring to FIGS. 1a, 1b and 1c, in one embodiment of the invention, an optional electric drying blower 180 may be used. The blower 180 may introduce a high volume of air into the filtration chamber 150. This may impose a slight pressure on the filtration chamber 150 and promotes further dewatering and subsequent drying of the agglomerated solids captured in the filter bag 155. The blower 180 may be controlled by the control panel 160 and may be operated either automatically or manually as needed. In another embodiment of the invention, drying may be accomplished by exposing the filter bags 155 to ambient air.

The air blower 180 may be controlled through the control panel 160 which may be set up to operate in any number of timed cycles or in a continuous drying mode. A portion of the air current is directed to the outside of the filter bags 155 to dry the wet filter bags 155. In one embodiment, the blower inlet may comprise a muffler (not shown) for noise abatement. The sludge dewatering apparatus 100 may further comprises an exhaust silencer (not shown) with, or without, activated carbon for any odor control, as needed. The drying air may be supplied at ambient temperature. In another embodiment, the sludge dewatering apparatus 100 optionally comprises an inline heater unit (not shown) to provide heated or temperature controlled drying air to accelerate the drying of the filter bags. Advantageously, the sludge dewatering apparatus 100 operates at atmospheric conditions, or slightly above it, due to the drying air current.

Referring back to FIG. 1a, a substantially rigid primary platform 170 may be hingedly connected to the primary mounting rack 120. The primary platform 170 may be juxtaposed adjacent the primary filtration chambers 150. The primary platform 170 may be configured to support the weight of an operator. The operator may conveniently stand on the primary platform 170 to remove and replace the soiled or spent filter bags by uncovering the access lids. This may be done without using any additional tools or equipment such as a dolly. Since the dewatering of the agglomerated stream may occur by gravity draining and with the application of minimal pressure, removal of the soiled industry standard filter bags may be facilitated even when the sludge dewatering apparatus 100 is in operation. The operator may also replace a spent filter bag with a new or unused filter bag when the sludge dewatering apparatus 100 is in operation.

The effluent or fluid released during the dewatering may be substantially devoid of potentially harmful solid wastes. The effluent may be environmentally benign and may be safely disposed offshore or at a non-hazardous waste disposal facility. In one embodiment of the invention, the effluent may be dechlorinated prior to discharge.

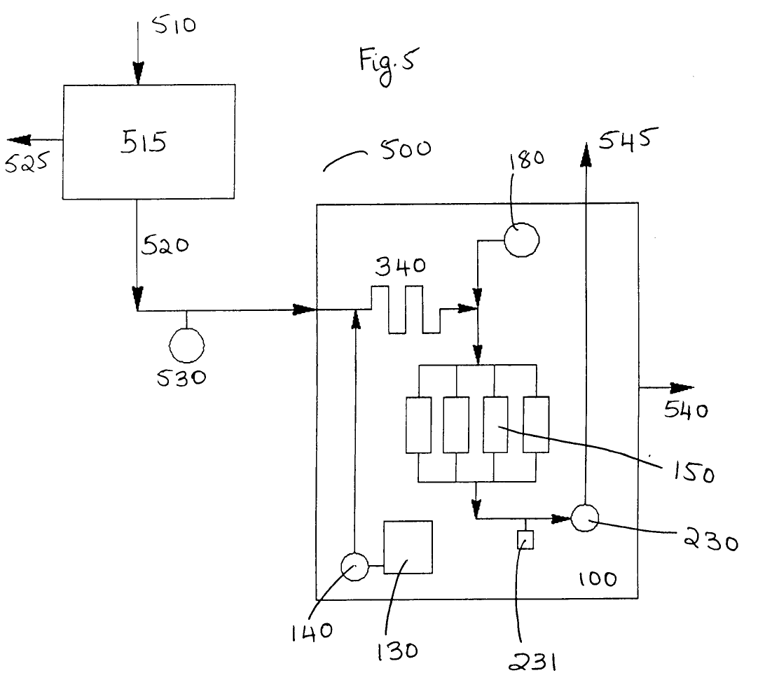

Referring now to FIG. 4, the self-contained primary module 110 may be expanded for further or larger scale sludge dewatering by connecting a secondary module 410 to the primary module. The secondary module 410 further comprises a secondary mounting rack 420 for supporting a secondary filtration station comprising one or more secondary filtration chambers 450. The secondary filtration chambers 450 correspond structurally to the primary filtration chambers 150. The secondary module 410 further comprises a secondary platform 470 to allow an operator to remove a spent filter bag from the secondary filtration chamber 450. The primary platform 170 may be coupled to the secondary mounting rack 420 to expand the dewatering capacity. Secondary piping means (not shown) run beneath the primary module 110 and secondary module 410. The secondary piping means transfer agglomerated or polymerized wastewater streams to the secondary module 410 for filtration in the secondary filtration chambers 450. The secondary piping means comprise selectively actuatable valves (not shown) controlled by the control panel 160 in the primary module 110. The agglomerated stream may be introduced into a filter bag until it reaches a pre-determined fill level, or a pre-determined fill time lapses or the density of the filled filter bag exceeds a pre-measured level. The agglomerated stream may then be introduced into one or more new or unused filter bags in the secondary filtration chambers 450. The dewatering apparatus 400 may be further expanded by coupling the secondary platform 470 to a mounting rack of a tertiary module 430. The tertiary module 430 may also comprise a plurality of filtration chambers 440 for facilitating dewatering and subsequent drying of an agglomerated stream and a platform 460 for supporting the weight of an operator. This modular design may allow multiple modules to be coupled to the primary module 110 for the purposes of increasing the overall filtration and dewatering capacity of the sludge dewatering apparatus 400.

Referring back to FIG. 1a, the sludge dewatering apparatus 100 continues to operate as long as it continues to receive a sludge transfer signal. When the receipt of the sludge transfer signal is stopped or halted, the sludge dewatering apparatus 100 may go into an idle mode, deactivating the sludge transfer and polymer injection pump 140, thereby allowing the solids captured in the filter bags to gravity drain and dry. If the electric blower is used, the blower may continue to operate even when the sludge dewatering apparatus 100 is in idle mode to encourage accelerated drying. The control panel 160 manages all cycles of operation along with pneumatic and other electrical control items to activate the valves and pumps, and to provide for a continuous dewatering and filtration operation.

Referring now to FIG. 5, a system for dewatering sludge 500 may comprise a wastewater treatment system 515 in fluid connection with the sludge dewatering apparatus 100 described previously. The wastewater 510 is introduced into the wastewater treatment apparatus 515 where it undergoes treatment to produce a dechlorinated and sanitized effluent 525. Sludge 520 containing entrained solids may be discharged from the wastewater treatment apparatus 515. The sludge 520 may be pumped to the sludge dewatering apparatus 100 when a turbidity sensor 530 on a sludge discharge line detects a pre-determined turbidity level.

An exemplary wastewater treatment system is described in U.S. Ser. No. 12/621,291, the contents of which are incorporated by reference herein. Wastewater, and in particular, marine wastewater comprises raw sewage, black water, gray water and combinations thereof, organic and inorganic solids, bacteria and gases. Solids suspended in the wastewater may be ground by running the collected wastewater through a macerator pump. A primary macerated wastewater stream comprising finely ground solids may be passed through an electrolytic cell. The electrolytic cell oxidizes and disinfects the primary macerated wastewater stream. The ground solids in the disinfected wastewater stream may be further agglomerated or flocculated in an electrocoagulation cell. The agglomerated solids, residual gases and a substantially clarified effluent may be separated from each other by allowing the fluid to pass through a degasification chamber followed subsequently by settling the fluid in one or more settling and clarifying tanks. The sludge comprising the agglomerated solids settles to the bottom of the tanks and is discharged into a sludge discharge line.

Referring back to FIG. 5, the sludge dewatering apparatus 100 comprises a polymer injection pump 140 which introduces a pre-measured quantity of one or more, or a combination of one or more, polymers stored in a polymer storage tank 130 into the sludge 530 entering the sludge dewatering apparatus 100. The polymer is mixed with the sludge using an in-line mixer 340 and a stream comprising agglomerated solid particles is introduced into a primary filtration station comprising one or more primary filtration chambers 150. The primary filtration chambers 150 comprise industry standard filter bags. The agglomerated stream is subjected to high volume air drying using an optional blower 180. This results in dewatering of the sludge and a solids-free effluent is filtered through the sidewalls of the filter bag. The dewatered sludge 540 may be discarded by removing the spent filter bags. The effluent may be collected in a piping header. When a drain level switch 231 detects a pre-determined level of collected effluent, a drain pump 230 drains or discharges the effluent 545 to an off-shore location or another designated effluent discharge location.

The soiled or spent filter bag 155 may be disposed by incineration or by other known disposal means. A clean filter bag 155 may now be positioned within the filtration chamber 150 to receive another stream of agglomerated sludge. The removal of soiled filter bags and insertion of clean filter bags 155 may be performed when the sludge dewatering apparatus 100 is operational.

In a typical liquid bag filter, once the bag has filtered as much particulate matter as it is capable of, the bag must be removed from its sealed housing. This spent bag is normally still very wet and heavy since the bag has been ‘blinded’ (or blocked off) due to the steady liquid stream passing through it. This wet bag is difficult to remove due to the bag retaining a certain amount of liquid, as the blinded off bag does not facilitate further dewatering. This causes several potential health and safety issues for the operator removing the bag, including: i) spillage of liquid upon bag removal; ii) difficulty in removing the bag because the retained liquid causes the bag to be heavier; iii) putting the operator or person removing the bag at risk of being splashed, or coming into contact with the liquid; and iv) requirement of non-standard disposal methods to insure proper disposal, which in turn requires the provision of larger than needed disposal receptacles or bins. In contrast, the one or more embodiments of the sludge dewatering apparatus 100 provide a dried filter bag for disposal, wherein the filter bag 155 only retains trace amounts of residual fluid, and therefore the disposal of the filter bags is sanitary, environmentally benign and poses limited health hazards to the operator.

In another embodiment, the primary filtration station comprises housing for mounting the one or more primary filtration chambers. In another embodiment, the housing further comprises a turntable having one or more apertures for receiving the one or more primary filtration chambers.

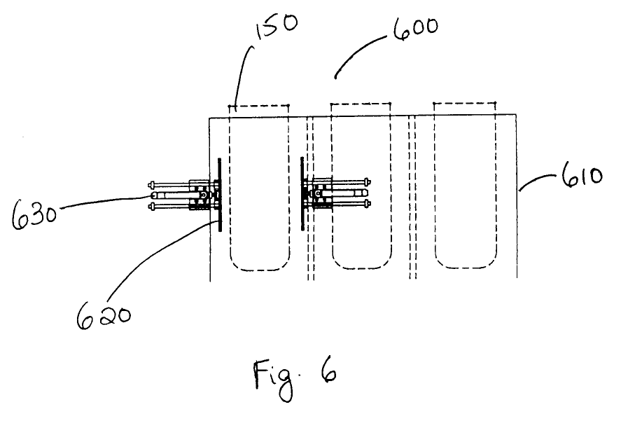

In one or more embodiments, as illustrated in FIG. 6, the housing 610 further comprises one or more pairs of integral actuatable dewatering or filter bag press plates 620. A pair of filter bag press plates 620 may converge on the filter bags 150 to effectively squeeze the particulate mass captured in the filter bag 150 to a further concentrated dewatered state. The filter bags 150 may articulate internally to dewater the sludge. The filter bag press plates 620 may comprise anodized aluminum or coated steel. A cylinder may be attached to each filter bag press plate 630. The cylinders 630 may be pneumatically, electrically, or hydraulically actuated. The cylinders 630 may be controlled by the PLC in the control panel. The compression of the filter bag 150 may compact the particulate mass in the agglomerated stream which then settles at the bottom of the filter bag 150. The dewatered fluid passes through the filter bag 150 and is collected in a sump area or a piping header.

It should be understood and accepted by those skilled in the art that embodiments of the invention may incorporate certain changes in bag quantities, drying temperature rates, general layout to suit a purpose and specific articulation principles whereas the spirit of the invention claimed is not debased.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms as used herein are shown below. To the extent a term used in a claim is not defined below, it should be given the broadest definition persons in the pertinent art have given that term as reflected in printed publications and issued patents at the time of filing.

It is contemplated that the embodiments described herein may be used at marine facilities, such as marine vessels, including ships and platforms, for example. Tight quarters in the marine facilities generally make installation of wastewater treatment systems difficult, if not impossible for many commercial applications. However, embodiments of the invention further provide a sludge dewatering apparatus having a small footprint and overall size, thereby easing installation concerns.

While the foregoing is directed to embodiments of the present invention, other and further embodiments of the invention may be devised without departing from the basic scope thereof and the scope thereof is determined by the claims that follow. The inventions are not limited to the described embodiments, versions or examples, which are included to enable a person having ordinary skill in the art to make and use the inventions when the information in this patent is combined with available information and technology.

1. A method for dewatering sludge, the method comprising:
introducing a pre-measured quantity of one or more polymers into the sludge to agglomerate entrained solids;
routing the agglomerated sludge to an integral primary filtration station, the primary filtration station comprising one or more primary filtration chambers, each of the primary filtration chambers further defining a cylindrical cavity for receiving at least one industry standard filter bag; and
dewatering the agglomerated sludge within the filter bag.

2. The method of claim 1, further comprising mixing in-line the polymers with the sludge prior to routing the agglomerated sludge to the primary filtration station.

3. The method of claim 1, further comprising controlling the routing of the agglomerated sludge by selectively actuating one or more valves, the valves connected to piping transferring the agglomerated sludge to the filter bag.

4. The method of claim 1, further comprising introducing a high volume of air into the primary filtration chambers for facilitating dewatering of the agglomerated sludge.

5. The method of claim 1, further comprising introducing heated air into the primary filtration chambers for facilitating drying of the agglomerated sludge retained in the filter bag.

6. The method of claim 1, further comprising compacting the agglomerated sludge within the filter bag by mechanically pressing the filter bag, the mechanical pressing further facilitating dewatering of the agglomerated sludge.

7. The method of claim 1, wherein the dewatering of the agglomerated sludge is a mechanical step selected from the group consisting of gravity draining, blow drying, heating, vacuuming, squeezing and pressing.

8. The method of claim 1, comprising collecting an effluent drained from sidewalls of the filter bag during the dewatering, wherein the level of the collected effluent is monitored, and further wherein the effluent is discarded when the effluent level reaches a pre-determined level.

9. The method of claim 1, further comprising coupling one or more filtration stations to the primary filtration station for expanding sludge dewatering capacity.

10. A sludge dewatering apparatus comprising:
a self-contained primary module, the primary module comprising a primary mounting rack configured to support:
an integral sludge transfer pump;
a polymer storage tank;
a polymer injection pump connected to the polymer storage tank;
a primary filtration station comprising one or more primary filtration chambers, each of the primary filtration chambers defining a cylindrical cavity configured to receive one or more industry standard filter bags therein; and
a substantially rigid primary platform perpendicularly oriented and securably coupled to the primary mounting rack, wherein the primary platform is positioned adjacent to the primary filtration chambers.

11. The sludge dewatering apparatus of claim 10, wherein the primary filtration chamber comprises a durable non-corrosive material.

12. The sludge dewatering apparatus of claim 11, wherein the non-corrosive material comprises polyvinyl chloride (PVC) or coated steel.

13. The sludge dewatering apparatus of claim 10, wherein the primary filtration chamber comprises an upper access lid, the access lid further comprising a handle pivotally connected to an upper surface of the lid.

14. The sludge dewatering apparatus of claim 10, wherein the filter bag further comprises at least one pair of built-in handles.

15. The sludge dewatering apparatus of claim 10, further comprising:
piping means for transferring agglomerated sludge to the one or more filtration chambers;
selectively actuatable valves positioned on the piping means; and
a control panel comprising a programmable logic controller (PLC), the PLC configured to control the valves.

16. The sludge dewatering apparatus of claim 10, further comprising:
a piping header disposed beneath the filtration chambers;
automated means for detecting an effluent level in the piping header; and
a drainage pump in fluid connection with the common piping header.

17. The sludge dewatering apparatus of claim 10, further comprising one or more pairs of dewatering plates, wherein the filter bag is positioned between the pair of dewatering plates.

18. The sludge dewatering apparatus of claim 17, further comprising mechanical and/or hydraulic means for actuating the dewatering plates.

19. The sludge dewatering apparatus of claim 10, further comprising an air blower disposed adjacent the filtration chambers.

20. The sludge dewatering apparatus of claim 10, further comprising one or more secondary modules disposed laterally, the secondary module comprising a secondary filtration station, the secondary filtration station further comprising one or more secondary filtration chambers and a secondary platform, wherein the secondary module is coupled to the primary platform.

21. A sludge dewatering system, the system comprising:
a wastewater treatment system configured to treat wastewater; and
a sludge dewatering apparatus upstream from the wastewater treatment system, the sludge dewatering apparatus comprising:
a self-contained primary module, the primary module comprising a primary mounting rack configured to support:
an integral sludge transfer pump;
a polymer storage tank;
a polymer injection pump connected to the polymer storage tank;
a primary filtration station comprising one or more primary filtration chambers, each of the primary filtration chambers defining a cylindrical cavity configured to receive one or more industry standard filter bags therein; and
a substantially rigid primary platform perpendicularly oriented and securably coupled to the primary mounting rack, wherein the primary platform is juxtaposed adjacent to the primary filtration chambers,
wherein the sludge dewatering apparatus is connected to the wastewater treatment system by a sludge transfer pipe.
